(19) United States
(12) Patent Application Publication
(10) Pub. No.: US 2024/0038207 A1
(43) Pub. Date: Feb. 1, 2024

(54) LIVE DISTRIBUTION DEVICE AND LIVE DISTRIBUTION METHOD

(71) Applicant: YAMAHA CORPORATION, Hamamatsu-shi (JP)

(72) Inventors: Taiki SHIMOZONO, Hamamatsu-shi (JP); Keijiro SAINO, Hamamatsu-shi (JP)

(21) Appl. No.: 18/487,519

(22) Filed: Oct. 16, 2023

Related U.S. Application Data
(63) Continuation of application No. PCT/JP2021/016793, filed on Apr. 27, 2021.

(51) Int. Cl. G10H 7/00

(52) U.S. Cl. CPC G10H 7/00; G10H 2240/201; G10H 2240/091

(57) ABSTRACT

A live distribution device includes an obtaining circuit, a data processing circuit, and a distribution circuit. The obtaining circuit is configured to obtain a piece of music and/or a user reaction to the piece of music. The user reaction is obtained from a viewing user, among a plurality of users, who is viewing a performance. The data processing circuit is configured to generate processed data based on the piece of music and/or the user reaction obtained by the obtaining circuit. The processed data indicates how the performance is viewed by the viewing user. The distribution circuit is configured to distribute the generated processed data to a terminal device of a non-viewing user, among the plurality of users, who is not viewing the performance.

### CROSS-REFERENCE TO RELATED APPLICATIONS

The present application is a continuation application of International Application No. PCT/JP2021/016793, filed Apr. 27, 2021. The contents of this applications are incorporated herein by reference in their entirety.

### BACKGROUND

### Field

The present disclosure relates to a live distribution device and a live distribution method.

### Background Art

JP 2008-131379 A discloses a system that distributes, live, a moving image of singing performance and/or musical performance.

A user determines whether to view a live distribution. In a case where the user has determined to view the live distribution, the user makes an input operation indicating an intension to view the live distribution. In this manner, the user is able to view the live distribution.

Before the user determines whether to view a live distribution, there may be a case where the user imagines how the performance in the live distribution actually is. For example, the user may imagine a piece(s) of music performed in a live distribution, or imagine the level of excitement among the audience in the live venue. Then, if the user is interested in the live distribution, the user may determine to view the live distribution. A problem, however, is that while the user is making a decision about entering the live venue, the user will not be informed about how the performance and the atmosphere are inside the live venue.

The present disclosure has an object to provide a live distribution device and a live distribution method that solve the above-described problem.

### SUMMARY

One aspect is a live distribution device that includes an obtaining circuit, a data processing circuit, and a distribution circuit. The obtaining circuit is configured to obtain a piece of music and/or a user reaction to the piece of music. The user reaction is obtained from a viewing user, among a plurality of users, who is viewing a performance. The data processing circuit is configured to generate processed data based on the piece of music and/or the user reaction obtained by the obtaining circuit. The processed data indicates how the performance is viewed by the viewing user. The distribution circuit is configured to distribute the generated processed data to a terminal device of a non-viewing user, among the plurality of users, who is not viewing the performance.

Another aspect is a live distribution method that includes obtaining a piece of music and/or a user reaction to the piece of music. The user reaction is obtained from a viewing user, among a plurality of users, who is viewing a performance. The method also includes generating processed data based on the piece of music and/or the user reaction. The processed data indicates how the performance is viewed by the viewing user. The method also includes distributing the generated processed data to a terminal device of a non-viewing user, among the plurality of users, who is not viewing the performance.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a block diagram of a configuration of a live distribution system 1, which uses a live distribution device 10 according to one embodiment.

FIG. 2 is a schematic functional block diagram of a configuration of the live distribution device 10.

FIG. 3 illustrates an example of filter type data stored in a storage 102.

FIG. 4 is a sequence chart for describing a flow of processing performed by the live distribution system 1.

### DESCRIPTION OF THE EMBODIMENTS

The present development is applicable to a live distribution device and a live distribution method.

The live distribution device 10 according to the one embodiment will be described by referring to the accompanying drawings.

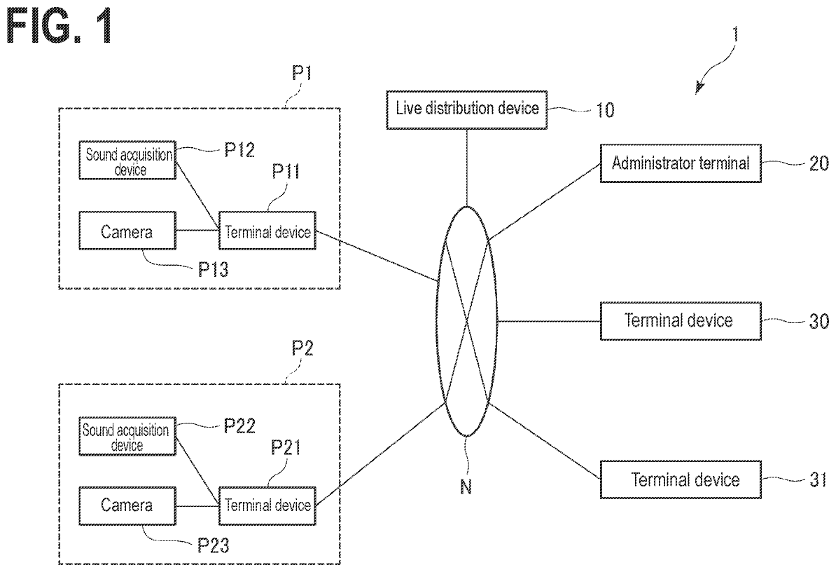

FIG. 1 is a block diagram of a configuration of the live distribution system 1. The live distribution system 1 uses the live distribution device 10 according to the one embodiment.

The live distribution system 1 includes the live distribution device 10, an administrator terminal 20, a performer device group P1, a performer device group P2, a terminal device 30, and a terminal device 31. The live distribution device 10, the administrator terminal 20, the performer device group P1, the performer device group P2, the terminal device 30, and the terminal device 31 are communicatively connected to each other via a network N.

The live distribution device 10 generates content based on a live musical performance performed by a performer(s). Then, the live distribution device 10 performs a live distribution of the content, that is, the live distribution device 10 distributes, in real-time, the content to a terminal(s) of a user(s). An example of the live distribution device 10 is a computer.

In a live distribution, there is a first case where performers gather in one live venue and perform one piece of music in the one live venue, and there is a second case where performers are located at different live venues and play different parts to perform one piece of music together at different live venues. The live distribution device 10 is capable of performing a live distribution in both the first case and the second case. In the second case, where performers perform at different live venues, a performer device group is provided at each of the live venues. The live distribution device 10 synthesizes pieces of the performance data obtained from the performer device groups, and regards the synthesized performance data as live distribution data. Then, the live distribution device 10 transmits the live distribution data to the user terminal device(s).

A live venue may be any place where a musical performance can be performed, examples including a home, a studio, a live house, and a concert venue.

A live venue may also be made up of a stage and an audience seat. A live venue may also be made up of combinations of a stage and an audience seat. For example, as in an open-air music festival, there may be a case where a plurality of stages are provided in one live venue. In a case where a plurality of stages are provided in one live venue, a performer(s) appears on each stage of the plurality of stages and performs a performance on the each stage. There may be a case where a plurality of performers located at different places perform a performance. In this case, performance signals from the different places may be synthesized to generate a musical performance on one stage.

In a case where a plurality of stages are provided in one live venue, one piece of music is performed for each stage of the stages.

The performer device group P1 and the performer device group P2 are used by performers appearing on a stage. The following description is an example in which performers located in a first venue use the performer device group P1, performers located in a second venue different from the first venue use the performer device group P2, and the performers located in the first and second venues perform one piece of music together. It is to be noted that one piece of music may be performed in one venue, instead of in a plurality of venues. In this case, a single performer device group may be used. It is also to be noted that while in the following description two performer device groups are used, there may be a case where one piece of music is performed in three or more venues. In this case, a performer device group may be provided at each venue of the three or more venues. For example, in a case where there are different performance parts such as a vocal, a guitar, a base, a drum, and a keyboard, a different performer device group may be used to play each part at each venue.

The performer device group P1 includes a terminal device P11, a sound acquisition device P12, and a camera P13. The terminal device P11 is communicatively connected to the sound acquisition device P12 and the camera P13, and is communicably connected to the network N. The terminal device P11 includes various input devices such as a mouse, a keyboard, and a touch panel, and includes a display device. An example of the terminal device P11 is a computer.

The sound acquisition device P12 acquires sound and outputs, to the terminal device P11, a sound signal corresponding to the acquired sound. For example, the sound acquisition device P12 generates an analogue sound signal based on the acquired sound, and subjects the analogue sound signal to AD (analogue-digital) conversion. In this manner, the sound acquisition device P12 converts an analogue sound signal to a digital sound signal. The sound acquisition device P12 outputs the digital sound signal to the terminal device P11 as a performance signal.

It suffices that the sound acquisition device P12 has at least one function among a sound sensor that acquires musical performance sound output from a musical instrument, an input device that receives a sound signal output from an electronic instrument, and a microphone that acquires a performer's vocal sound. While in this description a single sound acquisition device P12 is connected to the terminal device P11, a plurality of sound acquisition devices may be connected to the terminal device P11. For example, in a case where a performer sings while playing a musical instrument, it is possible to use a sound acquisition device as a microphone and another sound acquisition device to acquire sound of the musical instrument.

The camera P13 takes an image of the performer who uses the performer device group P1. Then, the camera P13 outputs the image data to the terminal device P11. An example of the image data is movie data.

The performer device group P2 includes a terminal device P21, a sound acquisition device P22, and a camera P23. The terminal device P21 has a function similar to the function of the terminal device P11, the sound acquisition device P22 has a function similar to the function of the sound acquisition device P12, and the camera P23 has a function similar to the function of the camera P13. In view of this, the terminal device P21, the sound acquisition device P22, and the camera P23 will not be elaborated upon here.

The administrator terminal 20 is used by an administrator who is in charge of content staging in a live distribution. An example of the administrator is a designer. Another example of the administrator is a performer.

The terminal device 30 and the terminal device 31 are used by users who view a live distribution. Each of the terminal device 30 and the terminal device 31 is used by a different user.

The terminal device 30 includes elements such as an input device, a speaker, a display device, and a communication module. The terminal device 30 is communicatively connected to the network N via the communication module.

The input device is a device capable of receiving an input operation, examples including a mouse, a keyboard, and a touch panel. The speaker converts a digital performance signal to an analogue signal using a D/A conversion circuit, and amplifies the analogue signal using a build-in amplifier. Then, the speaker emits the analogue signal in the form of sound. The display device includes a liquid-crystal driving circuit and a liquid-crystal display panel. The liquid-crystal driving circuit receives an image signal distributed from the live distribution device 10. Based on the image signal, the liquid-crystal driving circuit generates a drive signal to drive the liquid-crystal display panel. Then, the liquid-crystal driving circuit outputs the drive signal to the liquid-crystal display panel. The liquid-crystal display panel includes pixels, and drives the element of each of the pixels based on the drive signal output from the liquid-crystal driving circuit to display an image corresponding to image data.

Examples of the terminal device 30 include a computer, a smartphone, and a tablet.

The terminal device 30 receives an image signal from the live distribution device 10, and displays the image signal on the display screen of the terminal device 30. Based on the image signal, the terminal device 30 generates three-dimensional imaginary-space information indicating a live venue in an imaginary space. Specifically, the terminal device 30 generates an image signal showing three-dimensional information of the live venue as seen from a specified viewing position. The terminal device 30 displays the generated image signal on the display screen of the terminal device 30.

In response to an input operation made by the user, the terminal device 30 is capable of changing the viewing position and/or the direction of field of vision in the imaginary space. Then, the terminal device 30 displays an image signal based on the viewing position and/or the direction of field of vision. Specifically, the terminal device 30 is capable of displaying an image signal showing an image of a region that corresponds to the viewing position and/or the direction of field of vision in the live venue in the imaginary space.

The terminal device 31 has functions similar to the functions of the terminal device 30 and will not be elaborated upon here.

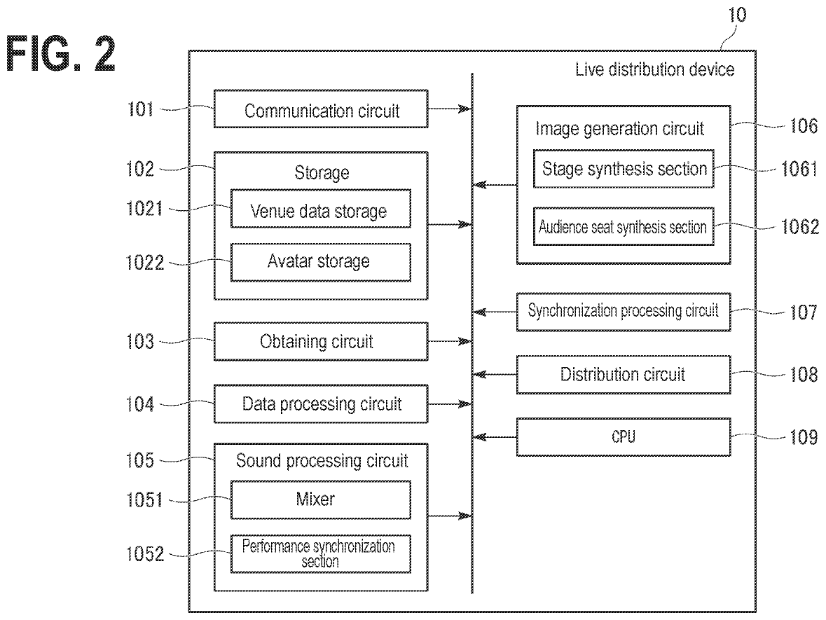

FIG. 2 is a schematic functional block diagram of a configuration of the live distribution device 10.

The live distribution device 10 includes a communication circuit 101, the storage 102, an obtaining circuit 103, a data processing circuit 104, a sound processing circuit 105, an image generation circuit 106, a synchronization processing circuit 107, a distribution circuit 108, and a CPU (Central Processing Unit) 109.

The communication circuit 101 is connected to the network N to communicate with other devices via the network N.

The storage 102 stores various kinds of data. The storage 102 includes a venue data storage 1021 and an avatar storage 1022.

The venue data storage 1021 stores venue data that indicates a live venue in an imaginary space. The venue data may be three-dimensional data that indicates a live venue in a three-dimensional space.

The avatar storage 1022 stores image data indicating avatars arranged in an imaginary space of a live venue. The avatars may be identical to each other in design for all users, or at least one avatar may be different in design from the other avatars for at least one user.

The storage 102 may be a storage medium such as an HDD (Hard Disk Drive), a flash memory, an EEPROM (Electrically Erasable Programmable Read Only Memory), a RAM (Random Access read/write Memory), and a ROM (Read Only Memory). Alternatively, the storage 102 may be a combination of these storage media. An example of the storage 102 is a nonvolatile memory.

The obtaining circuit 103 obtains at least one of: a sound generated in a performance; and a user reaction to the performance, the user reaction being obtained from a viewing user who is viewing a live distribution of the performance. The obtaining circuit 103 obtains the sound by receiving a performance signal from a terminal device of a performer of the performance. The obtaining circuit 103 obtains the user reaction to the performance by receiving various kinds of data (such as comment data, applause data, and user attribute data) transmitted from a terminal device of the viewing user.

Based on the data obtained by the obtaining circuit 103, the data processing circuit 104 generates processed data indicating how the performance is being viewed by the viewing user. The processed data is distributed by the distribution circuit 108 to a terminal device of a non-viewing user who is not viewing the live distribution. This enables the non-viewing user to, judging from the processed data, get an idea of how the performance and the atmosphere are inside the live venue, even at the time when the non-viewing user has not made a decision to view the content distributed live. Specifically, the data processing circuit 104 causes the distribution circuit 108 to distribute the processed data to the terminal device of the non-viewing user in the form of a preview screen before the live distribution is viewed.

The data processing circuit 104 performs a plurality of processings as described below. It is possible, however, that the data processing circuit 104 performs at least one of the following processings.

### Processing Based on Frequency Band

The performance signal that the data processing circuit 104 receives indicates the sound generated in the performance and includes a frequency band. The data processing circuit 104 generates the processed data by passing at least one sound component of the sound through a filter, the at least one sound component having a specific frequency included in the frequency band. While the frequency band of the sound component to be passed may be any frequency band, an example mainly discussed in this description is a low-frequency range (frequency bands corresponding to low sound).

The data processing circuit 104 generates the processed data such that the specific frequency of the at least one sound component depends on the piece of music or the genre of the piece of music. In this case, the data processing circuit 104 may use, for example, a filtering function to obtain a performance signal having the target frequency band.

The filtering function may be a digital filter or an analogue filter. In a case where a digital filter is used, a module that implements the digital filter function subjects a digital performance signal to digital signal processing to extract a signal component having the target frequency band.

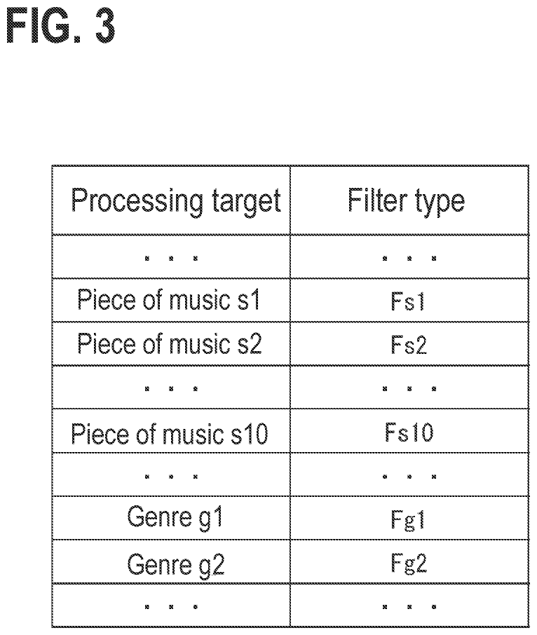

FIG. 3 illustrates an example of filter type data stored in the storage 102.

The filter type data is data that links a processing target to filter type.

Processing target is identification information indicating a target piece of music to be processed or the genre of the target piece of music. Filter type is identification information for identifying filter type. Different filter types indicate different frequencies of sound components to be passed through the filters. For example, a piece of music “s1” is linked to a filter type “Fs1”. This indicates that the “Fs1” filter is used for the piece of music “s1”. For example, a genre “g1” is linked to a filter type “Fg1”. This indicates that the “Fg1” filter is used for the genre “g1”.

Thus, the filter type data defines a filter of a unique characteristic used on a music-piece basis or a music-genre basis. The filter type data may be prepared in accordance with a designer's intention input by the designer using the administrator terminal 20. The filter type data may also be prepared in accordance with a performer's intention input by the performer using the performer's terminal device. This ensures that the filters used are suited for a designer's or a performer's intention as to the level of detail of performance to be provided to the non-viewing user.

Based on the filter type data stored in the storage 102, the data processing circuit 104 selects a filter that corresponds to the piece of music or the genre of the piece of music that is being distributed live. Then, the data processing circuit 104 obtains processed data by passing at least one sound component of the sound of music through the selected filter, the at least one sound component having a specific frequency included in the frequency band in the performance signal.

Thus, a filter is selected based on a piece of music or the genre of the piece of music. In this case, the range of performance signal to be shared (sharing range determined based on considerations such as frequency band and sound quality) can be changed based on the piece of music or the genre of the piece of music (such as pops, rock, acoustic music, and classical music). The appropriate range for sharing a performance signal would vary across different pieces of music and genres in order to make the non-viewing user interested in the live distribution. The above-described configuration takes this possibility into consideration. Specifically, a filter is select in consideration of the sharing range that effectively captures the interest of the non-viewing user. Also, since different music genres possess different tonal ranges, a sharing range can be set in consideration of the tonal range of a particular music genre.

In a case where a filtering function is used, the data processing circuit 104 may use a filter having such a characteristic that as the distance between the position of the performance in the imaginary space and the position of the non-viewing user who is not viewing the live distribution in the imaginary space is shorter, a high-frequency range of the frequency band is made wider in identifying the specific frequency from the frequency band.

### Processing Based on User Reaction

The data processing circuit 104 receives viewer data transmitted from the terminal device of the viewing user who is receiving the live distribution. Based on the viewer data, the data processing circuit 104 generates processed data that includes reaction data indicating an atmosphere of the live venue that is based on how the viewing user is viewing the live distribution. By using reaction data, an atmosphere of the live venue can be represented based on how the viewing user is viewing the live distribution, that is, a sound of applause filling the live venue can be represented.

The viewer data may be any data that indicates how the viewing user is viewing the live distribution or a user reaction to the performance. For example, the viewer data may include at least one of comment data, applause data (such as hand clapping data), and attribute data.

The data processing circuit 104 generates the reaction data using at least one data included in the viewer data and transmitted from the terminal device of the viewing user who is viewing the live distribution. The at least one data may be comment data indicating a comment regarding the performance, applause data indicating an applause action for the performance, or attribute data indicating an attribute of the viewer (viewing user).

The comment data is text data indicating a comment that is regarding the performance and that is transmitted from the terminal device of the viewing user who is viewing the live distribution. Examples of the comment data include a character string indicating an applause, a character string indicating to a user impression of the performance, and a character string indicating cheering to a performer(s). The comment data can be input, by the viewing user using the input device, on a comment entry field of the viewing screen on which to view the live distribution.

Upon obtaining the comment data from the terminal device of the viewing user, the data processing circuit 104 generates reaction data in the form of a predetermined sound that is based on the obtained comment data. In generating the reaction data in the form of a predetermined sound, the data processing circuit 104 may generate the reaction data by reading sound data stored in advance in a storage device. Examples of this sound data include a voice calling a performer's name, a responding voice in a “call and response” interaction, and an applause.

Also in generating the reaction data in the form of a predetermined sound, the data processing circuit 104 may ask the viewing user to make an utterance using a microphone and transmit the utterance to the data processing circuit 104 from the terminal device of the viewing user. In this manner, the data processing circuit 104 may store sound data on a user basis and use the sound data.

The data processing circuit 104 may also use a synthetic sound, instead of using the user's actual voice. In a case of a synthetic sound, the data processing circuit 104 may, for example, extract pieces of vocal material data from pieces of recorded sound data each including a recording of an actual vocal sound, and combine the extracted vocal material data to synthesize an audience voice. For example, the synthetic sound may be a voice calling a performer's name, a responding voice in a “call and response” interaction, or an applause.

In generating the reaction data in the form of sound, the data processing circuit 104 may generate a sound of a predetermined utterance as the reaction data, irrespective of what the comment is in the comment data. Alternatively, the data processing circuit 104 may generate, as the reaction data, a sound of an utterance that is based on the comment included in the comment data. For example, the data processing circuit 104 may generate a synthetic voice reading aloud a character string included in the comment data.

Thus, by generating reaction data based on comment data, the number of times of receipt of comment data per unit time and/or the timing of receipt of comment data (corresponding to an exciting part of music) can be used to represent the level of excitement among the audience in the live venue (the level of excitement among a plurality of viewing users who are viewing the live distribution). Then, the non-viewing user who is not viewing the live distribution yet can be informed of the level of excitement among the audience in the live venue.

The applause data is data indicating an applause action for the performance. The applause data is transmitted from the terminal device of the viewing user who is viewing the live distribution. Specifically, on the viewing screen on which to view the live distribution, the viewing user presses a hand-clapping button using the input device.

Upon obtaining the applause data from the terminal device of the viewing user, the data processing circuit 104 generates reaction data in the form of sound data that indicates an applause sound (such as a hand clapping sound) and that is based on the obtained applause data. In generating an applause sound as the reaction data, the data processing circuit 104 may generate the reaction data by reading applause sound data stored in advance in the storage device.

Thus, by generating reaction data based on applause data, the number of times of receipt of applause data per unit time and/or the timing of receipt of applause can be used to represent the level of excitement among the audience in the live venue (the level of excitement among a plurality of viewing users who are viewing the live distribution). Then, the non-viewing user who is not viewing the live distribution yet can be informed of the level of excitement among the audience in the live venue.

Attribute data is data indicating a viewer's attribute. More specifically, attribute data is data based on an attribute of a user who has decided to view a live distribution or an attribute of a viewing user who is viewing a live distribution. Examples of the attribute data include age and gender of such user.

In a case where the user pre-purchases an electronic ticket before the start of the live distribution, the attribute data of the user may be obtained at the timing of the pre-purchase. In a case where the user starts viewing the live distribution after the start of the live distribution, the attribute data of the user may be obtained at the timing of start of viewing the live distribution.

The data processing circuit 104 may obtain the attribute of the user who has decided to view the live distribution data by reading, from user database, user information including the attribute data. The user database may be included in the live distribution device 10 or may be stored in a server separate from the live distribution device 10.

The data processing circuit 104 obtains the attribute data of the viewing user who is viewing the live distribution from the user database based on a list of users who are viewing the live distribution.

In a case where the attribute data is stored in the terminal device of a user, the data processing circuit 104 may obtain the attribute data by, upon the user's input of an instruction indicating an intension to view the live distribution, causing the terminal device to transmit the attribute data to the live distribution device 10.

The data processing circuit 104 generates sound data as reaction data based on the obtained attribute data. The reaction data indicates the level of excitement of the user. For example, the data processing circuit 104 aggregates pieces of attribute data to obtain information regarding which age group and gender has a tendency to view the live distribution. Based on the tendency, the data processing circuit 104 generates the sound data. This sound data is stored in advance in, for example, a storage device such that the sound data corresponds to a particular combination of an age group and gender. The data processing circuit 104 generates the sound data by referring to the storage device and reading the sound data corresponding to the tendency of the obtained age group and gender.

For example, in a case where males in their twenties exhibit a tendency to view the live distribution, the sound data used indicates an enthusiastic applause from a plurality of young males. In a case where females in their twenties exhibit a tendency to view the live distribution, the sound data used indicates an enthusiastic applause from a plurality of young females. In a case where males in their forties exhibit a tendency to view the live distribution, the sound data used indicates an applause from a plurality of males in an age group beyond the twenties age range. Specifically, for an age group beyond the twenties age range, the sound data used indicates an applause somewhat milder than an enthusiastic applause.

Thus, by generating reaction data based on attribute data, the non-viewing user who is not viewing the live distribution yet can be informed of, in the form of applause sound, which age group and gender is dominant in the viewing users who are viewing the live distribution.

The reaction data generated by the data processing circuit 104 is not information indicating a performance itself; instead, the reaction data is data indicating a reaction obtained from a user who is viewing the performance.

The comment data and the applause data can be obtained from the terminal device of a user when the user views and reacts to a performance. In a case where the reaction data is generated from the comment data and the applause data, the present level of excitement of the viewing user who is viewing the live distribution can be communicated to another user. There may be a case where a user who is currently undecided regarding whether to view a live distribution is deliberating between this live distribution and other live distributions performed by other performers. In such situation, if there is a live distribution generating a high level of excitement among the audience, the user may decide to view the live distribution generating a high level of excitement among the audience.

In a case where the reaction data is generated from user attribute, such information can be obtained that what kind of attribute (such as age and gender) the user who has reacted to view live distribution has. This enables a user who is deliberating whether to view the live distribution to get an idea of a tendency as to what kind of users are in the live venue. In an actual live performance, the level of excitement may vary depending on the visiting viewers' ages and genders. For example, there may be a case where the raising of viewers' arms to the rhythm of the performance reflects their sense of excitement. For further example, there may be a case where viewers' sense of excitement is reflected through subtle body movements; however, once the performance concludes, this excitement is echoed by an applause. There could be a user who finds greater comfort when the user's way of enjoying a performance aligns more closely with the prevailing sense of excitement among other users. Such user is able to get information in advance regarding a user group in the venue based on the reaction data generated from user attribute. This enables the user to more easily determine whether to view the live distribution. Thus, information regarding the demographics of the viewers who are viewing the live distribution can be communicated to another user.

### Another Method of Processing Performance Signal

The data processing circuit 104 may perform processing of changing the way of processing a performance signal based on a lapse of time. For example, the data processing circuit 104 may distribute the performance signal as it is from the start of distribution of the processed data on the preview screen until the passage of a predetermined period of time. Then, upon passage of the predetermined period of time, the data processing circuit 104 may process the performance signal. In this case, a user is allowed to have a trial experience of the performance signal itself on the preview screen based on the processed data until the passage of the predetermined period of time. The predetermined period of time may be, for example, a unit running time of music equivalent to one piece of music or two pieces of music. This enables the user to have a trial experience on a music-piece basis, such as a trial experience of one piece of music and a trial experience of a plurality of pieces of music. Upon passage of the predetermined period of time, the data processing circuit 104 may perform processing such as processing using a filter. This enables the user to view the actual performance signal for a predetermined period of time and, judging from the viewed content, determine whether to actually view the live distribution.

### Another Method of Processing Performance Signal

The data processing circuit 104 may perform another processing on a performance signal. For example, the data processing circuit 104 may perform any one of: processing of adding noise to the performance signal; processing of degrading the performance signal in sound quality; and processing of converting a stereo performance signal into a mono performance signal.

In a case of performing the processing of adding noise, a synthesized sound of the performance signal and another sound can be generated. Even if a synthesized sound containing noise is provided, the performance content can be recognized to a substantial degree from the synthesized sound.

In a case of performing the processing of degrading the performance signal in sound quality, although the generated sound is not the performance signal itself, features of the performance content can be recognized to a substantial degree from the generated sound.

In a case of performing the processing of converting a stereo performance signal into a mono performance signal, a sound synthesized into one channel can be generated. Although the generated sound lacks a sense of space and dimension, the performance content can be recognized from the sound.

Thus, in a case where the data processing circuit 104 performs processing on the performance signal, the performance signal can be processed into a sound from which the performance content can be recognized to a substantial degree.

In a case where a plurality of stages are provided in one live venue, the data processing circuit 104 may generate processed data on a stage basis based on viewer data for each stage. Then, the data processing circuit 104 may synthesize pieces of the processed data generated on a stage basis. This synthesis may be based on the position of the non-viewing user who is not viewing the live distribution in the imaginary space and the position of each stage. Then, the data processing circuit 104 may transmit the synthesized processed data to the terminal device of the non-viewing user who is not viewing the live distribution.

The sound processing circuit 105 receives the performance signal obtained by the obtaining circuit 103.

The sound processing circuit 105 includes a mixer 1051 and a performance synchronization section 1052.

The mixer 1051 synthesizes mixing target performance signals that are among the performance signals obtained from the performer device groups. For example, the mixer 1051 receives a performance signal of a musical instrument (for example, a guitar) played by the performer corresponding to the performer device group P1, a vocal sound of the performer (for example, a vocal) corresponding to the performer device group P1, and a performance signal of a musical instrument (for example, a base) played by the performer corresponding to the performer device group P2. Then, the mixer 1051 generates a performance signal (a performance signal of an accompanied part) by mixing the performance signal of the musical instrument (for example, a guitar) played by the performer corresponding to the performer device group P1 with the performance signal of the musical instrument (for example, a base) played by the performer corresponding to the performer device group P2. In this case, the mixer 1051 outputs two performance signals, namely, the performance signal of the vocal sound of the performer (for example, a vocal) corresponding to the performer device group P1 and the performance signal of the accompanied part.

The performance synchronization section 1052 synchronizes performance signals obtained from the performer device groups of the performers in charge of the parts of one piece of music. For example, the performance synchronization section 1052 synchronizes a performance signal of the vocal sound of the performer corresponding to the performer device group P1, a performance signal of the musical instrument played by the performer corresponding to the performer device group P1, and a performance signal of the musical instrument played by the performer corresponding to the performer device group P2.

The image generation circuit 106 generates an image signal that is based on a piece of music performed by a performer(s). The image generation circuit 106 includes a stage synthesis section 1061 and an audience seat synthesis section 1062. The stage synthesis section 1061 synthesizes image data indicating a performer who is performing a piece of music over a stage in an imaginary space of a live venue indicated by venue data.

The image generation circuit 106 generates such an image signal that an image of the performer is synthesized over the stage in the imaginary space of the live venue by the stage synthesis section 1061 and that the avatar of the viewer is synthesized over the audience seat in the imaginary space of the live venue by the audience seat synthesis section 1062. The image generation circuit 106 transmits the generated image signal to the terminal device (the terminal device 30 or the terminal device 31) of the viewer via the communication circuit 101 and the network N.

The synchronization processing circuit 107 synchronizes the performance signal generated by the sound processing circuit 105 and the image signal generated by the image generation circuit 106.

The distribution circuit 108 distributes, via the communication circuit 101, content to the terminal device of the viewing user who is viewing the live distribution. The content includes the performance signal synchronized by the synchronization processing circuit 107 and the image signal.

The distribution circuit 108 also distributes, via the communication circuit 101, the generated processed data to the terminal device of the non-viewing user who is not viewing the live distribution. In transmitting the processed data, the distribution circuit 108 may distribute, via the communication circuit 101, the preview screen and the processed data to the terminal device of the non-viewing user who is not viewing the live distribution.

By the distribution circuit 108 transmitting the processed data to the terminal device of the non-viewing user, the non-viewing user is able to get an idea of the atmosphere inside the actual live venue as if the non-viewing user located outside the live venue were encountering sound leakage from within the live venue.

When each terminal device is connected to a portal website that provides a live distribution service, a distribution list screen is displayed on the terminal device showing a list of content that are being distributed live. On the distribution list screen, the user may input an instruction to select a piece of content via the input device. Upon input of the instruction, a preview (trial experience) screen is displayed for the user to determine whether to view the live distribution of the selected piece of content. Upon the user inputting via the input device an instruction on the preview screen indicating an intension to view the live distribution, a signal demanding the live distribution is transmitted to the live distribution device 10. Upon receipt of this demand, the live distribution device 10 performs a live distribution to the terminal device from which the demand has been transmitted. This enables the user to view the live distribution.

Whether the user determines to view the live distribution depends on the user's individual circumstances. For example, the determination may depend on which piece of music is being performed in the live distribution or how the atmosphere is inside the live venue. There also may be a case where a plurality of live distributions are performed at the same time. In this case, the user may want to carefully select which live distribution to view. Also, there are free live distributions and paid live distributions. In a case of a paid live distribution, the user may want to carefully determine whether to view the live distribution as compared with a free live distribution.

In this embodiment, the processed data generated by the data processing circuit 104 is output on the preview screen. If the processed data is output from the terminal device, the user is able to use the processed data as a clue to determine whether to view the live distribution. This enables the user to not only image how the live distribution is but also get an idea of, based on the processed data, how the performance is in the actual live venue and/or how the atmosphere is inside the live venue. Based on how the performance is in the actual live venue and/or how the atmosphere is inside the live venue, the user is able to determine whether to view the live distribution.

The distribution circuit 108 is also capable of distributing the performance signal to the terminal device of each performer. This enables the each performer to perform the each performer's own performance while listening to, using the speaker (or the headphone) of the terminal device, the sound of other performers performing at other places. This enables the each performer to perform while listening to the sound of other performers performing at other places.

The CPU 109 controls the elements of the live distribution device 10.

At least one of the obtaining circuit 103, the data processing circuit 104, the sound processing circuit 105, the image generation circuit 106, the synchronization processing circuit 107, and the distribution circuit 108 may be implemented by, for example, executing a computer program at a processor such as the CPU 109. Alternatively, these functions each may be implemented by a dedicated electronic circuit.

Next, an operation of the live distribution system 1 will be described.

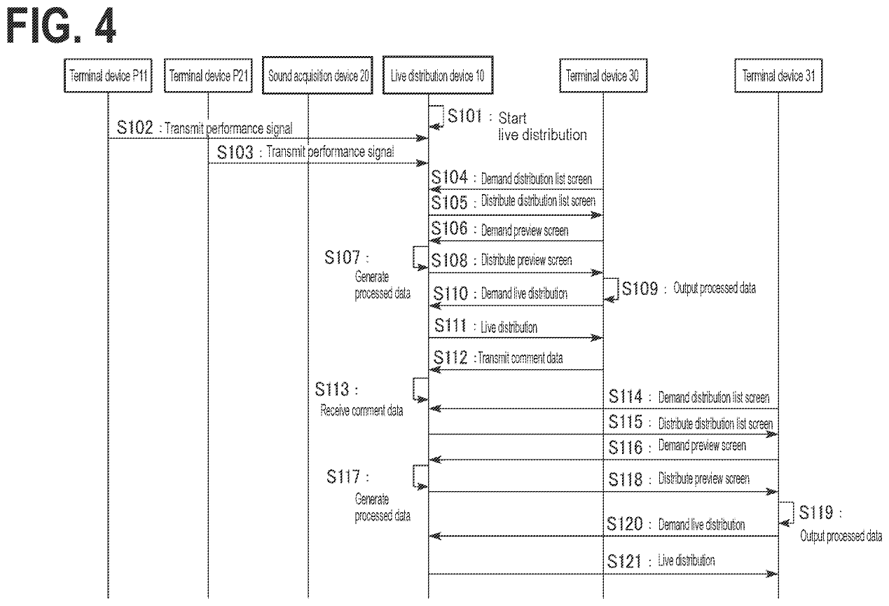

FIG. 4 is a sequence chart showing a flow of processing performed by the live distribution system 1.

Upon arrival of a live distribution start time, the live distribution device 10 starts a live distribution (step S101).

Upon start of the live distribution, each performer starts a musical performance. Upon start of a musical performance by a performer who is using the performer device group P1, the terminal device P11 transmits a performance signal to the live distribution device 10 (step S102). Upon start of a musical performance by a performer who is using the performer device group P2, the terminal device P21 transmits a performance signal to the live distribution device 10 (step S103).

After the performance signals have been transmitted from the terminal device P11 and the terminal device P21, the live distribution device 10 receives the performance signals.

The user of the terminal device 30 inputs a distribution demand for a distribution list screen via the input device of the terminal device 30. In response to this operation, the terminal device 30 transmits the distribution demand for a distribution list screen to the live distribution device 10 (step S104).

Upon receipt of the distribution demand for a distribution list screen from the terminal device 30, the live distribution device 10 distributes the distribution list screen to the terminal device 30 (step S105). This distribution list screen includes a list of content that are being distributed live.

The user of the terminal device 30 selects one piece of content from the list of content displayed on the distribution list screen, and operates the input device to click on a button corresponding to the selected piece of content. Upon clicking on the content button, the terminal device 30 transmits a distribution demand to the live distribution device 10 to demand a preview screen of the content corresponding to the clicked button (step S106).

Upon receipt of the distribution demand for a preview screen from the terminal device 30, the live distribution device 10 generates processed data based on at least one of the performance signal and the viewer data (step S107). For example, the data processing circuit 104 inputs the performance signal to a filter corresponding to the piece of music that is currently being performed, and regards the performance signal past the filter as processed data. This processed data includes a signal component of the performance signal which signal component is in a low-frequency range of the frequency band of the performance signal. Based on set list data transmitted from the terminal device of the performer before the live distribution, the data processing circuit 104 is capable of identifying the piece of music that is currently being performed. For example, the set list data is data that links an order of pieces of music to be performed to the scheduled performance time of each piece of music (or the time that has passed from the start of the live distribution for each piece of music).

Upon generating the processed data, the live distribution device 10 distributes, to the terminal device 30, the processed data and a preview screen for outputting the processed data (step S108).

Upon receipt of the preview screen and the processed data, the terminal device 30 displays the preview screen on the display device and outputs, from the speaker, the performance signal obtained as processed data (step S109). Specifically, at least one sound component, among the sound of the piece of music being performed, whose frequency band is in a low-frequency range is output from the speaker. This enables the user to listen to at least one sound component of the performance signal which sound component having a frequency band in a low-frequency range. Then, judging from the sound component having a frequency band in a low-frequency range, the user is able to feel the beat and rhythm of the piece of music, getting an idea of the mood of the piece of music being performed.

The processed data may also include an image signal, in addition to a sound signal. In a case where the processed data includes an image signal, the image signal included in the processed data is displayed in a partial region of the display region of the preview screen. In a case where a moving image signal is displayed as the processed data, it is possible to display, for example, only a partial region of the display screen indicated by the image signal distributed live.

Alternatively, it is possible to display the entire display screen indicated by the image signal. In this case, the performer's image included in the image signal may not necessarily be displayed as it is; instead, an outline of the performer extracted from the performer's image may be displayed. In this case, the user is able to recognize the performer's silhouette. Judging from the performer's silhouette, the user is able to identify who the performer is. Also, judging from the movement of the performer's silhouette, the user is able to get an idea of how the performance is.

The data processing circuit 104 may also lower the resolution of the entire display screen indicated by the moving image signal distributed live, and display the low-resolution display screen. In this case, the data processing circuit 104 may lower the resolution of the display screen to a degree where it is possible to identify such points as who the performer is and what musical instrument is being used, but finer details beyond these points are difficult to discern. Even from a low-resolution display screen, the user is able to identify the performer and/or the musical instrument used to a substantial degree. Then, judging from the performer and/or the musical instrument used, the user is able to get an idea of how the performance is.

The user is able to use, as a clue, the processed data output on the preview screen to determine whether to view the live distribution. In a case where the user has determined to view the live distribution, the user operates the input device to click on the view button displayed on the preview screen. Upon clicking on the view button, the terminal device 30 transmits a demand for the live distribution to the live distribution device 10 (step S110). In a case where the content of the live distribution is paid content, the user clicks on a purchase button for an electronic ticket. Upon clicking on the purchase button, the terminal device 30 transmits a purchase demand for an electronic ticket to the live distribution device 10.

Upon making the purchase demand for an electronic ticket, the live distribution device performs payment processing based on the purchase demand. Then, the live distribution device 10 generates an electronic ticket for the terminal device 30, permitting the user of the terminal device 30 to view the live distribution. The electronic ticket may be sold in advance, before the start of the live distribution. Alternatively, the electronic ticket may be sold any time there is a demand from the terminal device of the user after the start of the live distribution. The price of the electronic ticket may be a predetermined, uniform price. After the start of the live distribution, the price of the electronic ticket may be decreased based on the time that has passed from the start of the live distribution.

The live distribution device 10 performs a live distribution of content to the terminal device 30 that has been permitted to view the live distribution. The content includes image signals and performance signals synchronized to each other (step S111). For example, the live distribution device 10 receives image signals and performance signals transmitted from the performer device group P1 and the performer device group P2. Then, the live distribution device 10 generates a synthesized image signal by synthesizing the image signals over a live venue in an imaginary space, and synchronizes the synthesized image signal with the performance signals. Then, the live distribution device 10 distributes the resulting content. This enables the user of the terminal device 30 to view the live distribution. Before viewing the live distribution, the user has some knowledge on the content of the live distribution, based on the processed data. Specifically, before viewing the live distribution, the user knows whether the piece of music that the user wants to listen to is performed in the live distribution, and/or the level of excitement among the audience inside the live venue. Also, in a case where the user views the live distribution, such a situation is eliminated or minimized that the actual content of the live distribution is different from what the user expected.

While the user is viewing the live distribution, the user may input a comment on the input device of the terminal device 30. The comment may be an impression, cheering, or a response to a call of the performer (call and response). The user may also click on, via the input device of the terminal device 30, an applause button displayed on the screen of the live distribution. For example, upon input of the user's comment via the input device, the terminal device 30 transmits the input comment to the live distribution device 10 as comment data (step S112).

The live distribution device 10 receives the comment data transmitted from the terminal device 30 (step S113).

The user of the terminal device 31 inputs a distribution demand for a distribution list screen via the input device of the terminal device 31. In response to this operation, the terminal device 31 transmits the distribution demand for a distribution list screen to the live distribution device 10 (step S114).

Upon receipt of the distribution demand for a distribution list screen from the terminal device 31, the live distribution device 10 distributes the distribution list screen to the terminal device 31 (step S115).

The user of the terminal device 31 selects one piece of content from the list of content displayed on the distribution list screen, and operates the input device to click on a button indicating the selected piece of content. Upon clicking on the content button, the terminal device 31 transmits a distribution demand to the live distribution device 10 to demand a preview screen of the clicked content (step S116).

Upon receipt of the distribution demand for a preview screen from the terminal device 31, the live distribution device 10 generates processed data based on at least one of the performance signal and the viewer data (step S117). For example, the data processing circuit 104 obtains processed data by inputting the performance signal to a filter corresponding to the piece of music that is currently being performed. There may be a case where the piece of music performed at a particular time that has passed from the start of the performance is different from the piece of music at the time of generation of the processed data at step S107. In this case, the data processing circuit 104 generates processed data using a filter corresponding to the piece of music that is currently being performed. This ensures that the frequency band of the sound component to be passed can be changed based on the piece of music performed at the time of generation of the processed data. This, in turn, ensures that the processing performed is based on the piece of music that is currently being performed. For example, there may be a case where the musical instruments used vary depending on the piece of music. Also, some music genres are performed by bands, and some classical music compositions are performed by orchestras. In these cases, the frequency bands included in the performance signals vary across different ranges. In generating processed data, the data processing circuit 104 uses a filter corresponding to the piece of music or the genre of the piece of music. This ensures that the frequency band of the sound component to be passed can be changed based on the present performance.

In a case where viewer data has been obtained from the terminal device of another user who is already viewing the live distribution, the data processing circuit 104 may generate processed data including reaction data that is based on this viewer data. For example, the data processing circuit 104 may generate, as processed data, reaction data that is based on the comment data received at step S112. It is to be noted that the data processing circuit 104 may not necessarily be generate processed data based on a performance signal; instead, the data processing circuit 104 may only generate reaction data based on viewer data.

Upon generating the processed data, the live distribution device 10 distributes, to the terminal device 31, the processed data and a preview screen for outputting the processed data (step S118).

Upon receipt of the preview screen and the processed data, the terminal device 31 displays the preview screen on the display device and outputs, from the speaker, the performance signal included in the processed data (step S119). This enables the user to, by listening to the sound based on the processed data, get an idea of the atmosphere of the live distribution. For example, the user is able to listen to a performance sound based on the performance signal after being processed, or a sound of applause filling the live venue as indicated by the reaction data generated based on the viewer data.

The user uses the processed data as a clue to determine whether to view the live distribution. Specifically, the processed data output here is made also in light of viewer data that is based on a reaction from a viewing user who is actually viewing the live distribution. This enables the user to also consider a reaction from a viewing user who is actually viewing the live distribution. That is, the user is able to get an idea of an atmosphere of live venue in the form of how the performer is performing and how the users are viewing the performance. More specifically, before determining whether to view the live distribution, the user is able to have information about the atmosphere inside the live venue, whether the atmosphere is exciting or laid-back.

In a case where the user has determined to view the live distribution, the user operates the input device to click on the view button displayed on the preview screen. Upon clicking on the view button, the terminal device 31 transmits a demand for the live distribution to the live distribution device 10 (step S120). In a case where the content of the live distribution is paid content, payment processing associated with electronic ticket purchase is performed between the terminal device 31 and the live distribution device 10 in response to an input operation made by the user.

Upon completion of the payment processing, the live distribution device 10 generates an electronic ticket for the terminal device 31, permitting the user of the terminal device 31 to view the live distribution.

The live distribution device 10 performs a live distribution of content to the terminal device 31 that has been permitted to view the live distribution. The content includes image signals and performance signals synchronized to each other (step S121). In this manner, the user of the terminal device 31 is able to view the live distribution. In this case, the content of the live distribution has been recognized to a substantial degree based on the processed data. Therefore, the user views the live distribution knowing whether the piece of music that the user wants to listen to is performed. The user also views the live distribution already aware of the level of excitement among the audience inside the live venue as determined by a sound of applause filling the live venue. Also, in a case where the user views the live distribution, such a situation is eliminated or minimized that the actual content of the live distribution is different from what the user expected.

The one embodiment described hereinbefore has been regarding a case where a non-viewing user who is not viewing a live distribution yet determines whether to view the live distribution. In this case, upon input of a demand for viewing the live distribution, the user is able to enter a live venue in an imaginary space and view a performance in the live venue.

In particular, there may be a case where the user has identified a live distribution that the user is interested in but is currently undecided regarding whether to have a trial experience of the live distribution. In this case, the one embodiment makes it easier for the user to determine whether to view the live distribution based on processed data.

Also in the one embodiment, a preview screen is transmitted after a distribution list screen is displayed. A preview screen may, however, be distributed without a distribution list screen distributed. For example, a performer may share a preview screen on the performer's social media or a video streaming platform. In this case, the user may access the performer's social media or a video streaming platform to display a preview screen without displaying a distribution list screen, and have a trial experience based on the processed data.

Also in the one embodiment, in a case where a user is currently undecided regarding whether to view the live distribution, the performer is able to make the user interested in the live distribution while the live distribution is being performed.

Also in the one embodiment, a live distribution provider is able to establish an approach to encourage non-viewing users to engage with the live distribution, even after the start of the live distribution.

### Processing Based on Positions of Venue and Avatar in Imaginary Space

In the above-described one embodiment, in determining whether to enter the live venue, it is possible to change how to generate processed data depending on the position of the live venue and the position of the user.

For example, it is possible to change how to generate processed data depending on the actual position of the live venue and the actual current position of the user. The position of the live venue is represented by a combination of latitude and longitude. The actual current position of the user may be measured using a positioning function (for example, GPS (Global Positioning System)) of the terminal device of the user. In a case where processed data is generated based on the actual position of the live venue and the actual current position of the user and transmitted to the terminal device of the user, the user is able to determine, based on this processed data, whether to enter the actual live venue.

It is also possible to change how to generate processed data depending on, for example, the position of the live venue in an imaginary space and the position of the user's avatar in the imaginary space. In this case, the image generation circuit 106 calculates: coordinates of the live venue in a three-dimensional space indicating an imaginary space; and coordinates of the avatar operated by the user using the terminal device. The coordinates of the avatar are changeable based on an input operation of changing the position of the avatar on the input device of the terminal device of the user. Upon changing of the position of the avatar, the image generation circuit 106 successively obtains the coordinates of the avatar. The image generation circuit 106 obtains a vision field range of the avatar in the imaginary space based on the position of the avatar and the sight line direction of the avatar, and generates a moving image signal based on the vision field range. A distribution circuit 180 performs a live distribution of the generated moving image signal to the terminal device.

The data processing circuit 104 generates a performance signal that has been passed through a filter having characteristics corresponding to the coordinates of the live venue in the imaginary space generated by the image generation circuit 106 and the coordinates of the user's avatar. In a case where the coordinates of the live venue in the imaginary space are separated from the coordinates of the user's avatar by a predetermined distance, a lowpass filter is used having such a characteristic that allows only low-frequency sound to pass through the filter. As the distance between the coordinates of the user's avatar and the coordinates of the live venue is shorter, the filter used has such a characteristic that allows sound in a wider high-frequency range to pass through the filter, in addition to allowing low-frequency sound to pass through the filter. In this case, the storage 102 stores filter types and the distance between the live venue and the avatar. The data processing circuit 104 obtains the distance between the coordinates of the live venue and the coordinates of the avatar, and reads from the storage 102 a filter type corresponding to the obtained distance. Then, the data processing circuit 104 may cause the performance signal to pass through a filter corresponding to the read filter type to obtain processed data.

The data processing circuit 104 may also use a single filter. Specifically, as the distance between the coordinates of the live venue and the coordinates of the avatar is shorter, it is possible to widen the high-frequency range characteristic of the filter (increase the upper limit of the high-frequency range); as the distance is larger, it is possible to narrow the high-frequency range characteristic of the filter (decrease the upper limit of the high-frequency range).

With this configuration, in a case where the coordinates of the live venue in the imaginary space and the coordinates of the user's avatar are separated from each other by a predetermined distance, the data processing circuit 104 is able to process the performance signal into such a signal that only a low sound component of the performance signal is heard, and then output the signal on the preview screen. In the actual live venue, in a case where the user is separated from the live venue by a predetermined distance, the user can hear a low sound component of the performance sound leaking from the live venue. As the user becomes closer to the actual live venue, the user can hear not only low-frequency sound but also high-frequency sound higher in frequency band than low-frequency sound. In a case where low-frequency sound is heard, although the user can not listen to the performance signal itself, low-frequency sound in many cases includes performance sound of musical instruments (such as bass drums, and toms) that are easier to feel the beat and rhythm. By feeling the beat and rhythm, the user can get an idea of how the atmosphere is inside the live venue, although the user can not get details of musical performance of other musical instruments (such as guitar and vocal). As the avatar becomes closer to the live venue, the upper limit of the frequency band of the filter increases. This ensures that as the avatar becomes closer to the live venue, it becomes easier to hear performance sounds of other musical instruments (such as guitar and vocal). For example, as the avatar becomes closer to the live venue, the sounds of more musical instruments become increasingly clear. In the above-described one embodiment, the frequency band of the sound to be passed is changed based on the distance between the coordinates of the live venue in the imaginary space and the coordinates of the user's avatar. The user is able to move the position of the user's avatar closer to the live venue to listen to performance sounds of a wider frequency band. Also, the user can feel as if the user is approaching the actual live venue. This allows the user to experience a sense of exhilaration, as if the user is truly attending the live venue.

Inter-Stage Movement in Live Venue where a Plurality of Stages are Provided

In the above-described one embodiment, one group of performers perform in a live venue. The one embodiment, however, is also applicable to a case where a plurality of stages are provided in one live venue. An example of a case where a plurality of stages are provided in one live venue is an open-air music festival. In an open-air music festival, a plurality of stages are provided in one live venue. On each stage, a different group of performers performs different pieces of music. The musical performances on the stages are performed simultaneously. A user purchases an admission ticket and enters a browsing area of one stage of the plurality of stages in the live venue. The one stage is a stage on which a piece of music that the user wants to view is performed. In this manner, the user is able to listen to the piece of music on the one stage. It is possible to create an imaginary space featuring multiple stages for a live venue and conduct live distributions from this live venue.

In this case, the user is able to operate the user's avatar to move between the stages in the imaginary space. The user operates the user's avatar to approach any of the stages as if the user searches for a stage that might capture the user's interest more.

In this case, based on a relationship between the coordinates of each stage of the plurality of stages in the imaginary space and the coordinates of the user's avatar in the imaginary space, the data processing circuit 104 may synthesize a performance signal from the each stage. More specifically, there may be a case where the user's avatar is located in the space between the entrance of the imaginary space and the entrance of the live venue (this space is an area equivalent to a foyer). In this case, the data processing circuit 104 generates processed data by uniformly mixing the performance signals from the stages. This ensures that the performance signals from the stages can be heard approximately on the same level at the terminal device of the user.

Upon the user's avatar entering the live venue in the imaginary space, the data processing circuit 104 mixes the performance signals from the stages based on the distance between the position of the avatar and the position of the each stage. Specifically, as a stage is closer to the position of the avatar, the data processing circuit 104 may obtain performance signals from the stages using a filter that permits not only a low-frequency sound but also a high-frequency sound of a performance signal to pass through the filter. Then, the data processing circuit 104 may mix the obtained performance signals.

Also, the performance signal obtained by mixing the performance signals from the stages and the performance signal from the stage closest to the avatar may be subjected to cross-fade processing to obtain processed data.

Also in this case, the data processing circuit 104 may process the performance signals by performing auditory localization based on the position of the each stage and the position of the avatar. This enables the user to identify the direction of the performance, whether the stage is positioned to the right, left, in front, or behind the avatar. Also, the user is able to move the user's avatar in a direction from which a piece of music that captures the user's interest is audible. In this manner, the user can locate and reach a stage that captures the user's interest.

For example, there may be a case where a user is currently undecided regarding which performer (or stage) to select for a trial experience in a live distribution and wants to select a viewing target performer (or stage) based on the piece of music actually being performed and/or the atmosphere of the live venue. In this case, the above-described configuration of the one embodiment enables the user to more easily select a performance of a performer (or a stage).

A program for implementing the functions of each of the processing circuits illustrated in FIG. 1 may be stored in a computer readable recording medium. The program recorded in the recording medium may be read into a computer system and executed therein. An operation management may be performed in this manner. As used herein, the term “computer system” is intended to encompass hardware such as OS (Operating System) and peripheral equipment.

Also as used herein, the term “computer system” is intended to encompass home-page providing environments (or home-page display environments) insofar as the WWW (World Wide Web) is used.

Also, Also as used herein, the term “computer readable recording medium” is intended to mean: a transportable medium such as a flexible disk, a magneto-optical disk, a ROM (Read Only Memory), a CD-ROM (Compact Disk Read Only Memory); and a storage device such as a hard disk incorporated in a computer system. Also as used herein, the term “computer readable recording medium” is intended to encompass a recording medium that holds a program for a predetermined period of time. An example of such recording medium is a volatile memory inside a server computer system or a client computer system. It will also be understood that the program may implement only some of the above-described functions, or may be combinable with a program (s) recorded in the computer system to implement the above-described functions. It will also be understood that the program may be stored in a predetermined server, and that in response to a demand from another device or apparatus, the program may be distributed (such as by downloading) via a communication line.

While embodiments of the present disclosure have been described in detail by referring to the accompanying drawings, the embodiments described above are not intended as limiting specific configurations of the present disclosure, and various other designs are possible without departing from the scope of the present disclosure.

What is claimed is:

1. A live distribution device, comprising:
an obtaining circuit configured to obtain a piece of music and/or a user reaction to the piece of music, the user reaction being obtained from a viewing user, among a plurality of users, who is viewing a performance;
a data processing circuit configured to generate processed data based on the piece of music and/or the user reaction obtained by the obtaining circuit, the processed data indicating how the performance is being viewed by the viewing user; and
a distribution circuit configured to distribute the generated processed data to a terminal device of a non-viewing user, among the plurality of users, who is not viewing the performance.

2. The live distribution device according to claim 1,
wherein the piece of music has a sound having a frequency band, and
wherein the data processing circuit is further configured to generate the processed data by passing at least one sound component of the sound through a filter, the at least one sound component having a specific frequency included in the frequency band.

3. The live distribution device according to claim 2, wherein the specific frequency of the at least one sound component depends on the piece of music or a genre of the piece of music.

4. The live distribution device according to claim 1,
wherein as a distance between a position of the performance in an imaginary space and a position of the non-viewing user in the imaginary space is shorter, the data processing circuit is further configured to widen a high-frequency range of the frequency band in identifying the specific frequency from the frequency band.

5. The live distribution device according to claim 1, wherein the data processing circuit is further configured to generate reaction data based on viewer data transmitted from the terminal device of the viewing user, the reaction data indicating an atmosphere of a venue of the performance, the atmosphere being based on how the performance is being viewed by the viewing user.

6. The live distribution device according to claim 5,
wherein the performance comprises a plurality of performances performed in different stages in an imaginary space, and
wherein the data processing circuit is further configured to:
generate the processed data for each stage of the stages based on the viewer data from the each stage;
based on a position of the non-viewing user in the imaginary space and a position of the each stage in the imaginary space, synthesize pieces of the processed data generated for the stages; and
transmit the synthesized processed data to the terminal device of the non-viewing user.

7. The live distribution device according to claim 5, wherein the data processing circuit is further configured to generate the reaction data using data included in the viewer data and transmitted from the terminal device of the viewing user, the data comprising at least one of:
comment data that indicates a comment of the viewing user regarding the performance,
applause data indicating an applause action by the viewing user for the performance, and
attribute data indicating an attribute of the viewing user.

8. A live distribution method, comprising:
obtaining a piece of music and/or a user reaction to the piece of music, the user reaction being obtained from a viewing user, among a plurality of users, who is viewing a performance;
generating processed data based on the piece of music and/or the user reaction, the processed data indicating how the performance is being viewed by the viewing user; and
distributing the generated processed data to a terminal device of a non-viewing user, among the plurality of users, who is not viewing the performance.

9. The live distribution method according to claim 8,
wherein the piece of music has a sound having a frequency band,
wherein the method further comprises generating the processed data by passing at least one sound component of the sound through a filter, the at least one sound component having a specific frequency included in the frequency band, and
wherein as a distance between a position of the performance in an imaginary space and a position of the non-viewing user in the imaginary space is shorter, the method further comprises widening a high-frequency range of the frequency band in identifying the specific frequency from the frequency band.

10. The live distribution device according to claim 2, wherein the data processing circuit is further configured to generate reaction data based on viewer data transmitted from the terminal device of the viewing user, the reaction data indicating an atmosphere of a venue of the performance, the atmosphere being based on how the performance is being viewed by the viewing user.

11. The live distribution device according to claim 3, wherein the data processing circuit is further configured to generate reaction data based on viewer data transmitted from the terminal device of the viewing user, the reaction data indicating an atmosphere of a venue of the performance, the atmosphere being based on how the performance is being viewed by the viewing user.

12. The live distribution device according to claim 4, wherein the data processing circuit is further configured to generate reaction data based on viewer data transmitted from the terminal device of the viewing user, the reaction data indicating an atmosphere of a venue of the performance, the atmosphere being based on how the performance is being viewed by the viewing user.

13. The live distribution method according to claim 9, further comprising generating reaction data based on viewer data transmitted from the terminal device of the viewing user, the reaction data indicating an atmosphere of a venue of the performance, the atmosphere being based on how the performance is being viewed by the viewing user.

14. The live distribution device according to claim 10,
wherein the performance comprises a plurality of performances performed in different stages in an imaginary space, and
wherein the data processing circuit is configured to:
generate the processed data for each stage of the stages based on the viewer data from the each stage;
based on a position of the non-viewing user in the imaginary space and a position of the each stage in the imaginary space, synthesize pieces of the processed data generated for the stages; and
transmit the synthesized processed data to the terminal device of the non-viewing user.

15. The live distribution device according to claim 11,
wherein the performance comprises a plurality of performances performed in different stages in an imaginary space, and
wherein the data processing circuit is configured to:
generate the processed data for each stage of the stages based on the viewer data from the each stage;
based on a position of the non-viewing user in the imaginary space and a position of the each stage in the imaginary space, synthesize pieces of the processed data generated for the stages; and
transmit the synthesized processed data to the terminal device of the non-viewing user.

16. The live distribution device according to claim 12,
wherein the performance comprises a plurality of performances performed in different stages in an imaginary space, and
wherein the data processing circuit is further configured to:
generate the processed data for each stage of the stages based on the viewer data from the each stage;
based on a position of the non-viewing user in the imaginary space and a position of the each stage in the imaginary space, synthesize pieces of the processed data generated for the stages; and
transmit the synthesized processed data to the terminal device of the non-viewing user.

17. The live distribution method according to claim 13,
wherein the performance comprises a plurality of performances performed in different stages in an imaginary space, and
wherein the method further comprising:
generating the processed data for each stage of the stages based on the viewer data from the each stage;
based on a position of the non-viewing user in the imaginary space and a position of the each stage in the imaginary space, synthesizing pieces of the processed data generated for the stages; and
transmitting the synthesized processed data to the terminal device of the non-viewing user.

18. The live distribution device according to claim 4,
wherein the performance comprises a plurality of performances performed in different stages in an imaginary space, and
wherein the data processing circuit is further configured to:
generate the processed data for each stage of the stages based on the viewer data from the each stage;
based on a position of the non-viewing user in the imaginary space and a position of the each stage in the imaginary space, synthesize pieces of the processed data generated for the stages; and
transmit the synthesized processed data to the terminal device of the non-viewing user.

19. The live distribution device according to claim 6, wherein the data processing circuit is further configured to generate the reaction data using data included in the viewer data and transmitted from the terminal device of the viewing user, the data comprising at least one of:
comment data that indicates a comment of the viewing user regarding the performance,
applause data indicating an applause action by the viewing user for the performance, and
attribute data indicating an attribute of the viewing user.
